(19) United States
(12) Patent Application Publication
(10) Pub. No.: US 2011/0308743 A1
(43) Pub. Date: Dec. 22, 2011

(54) DEVICE AND METHOD FOR COVERING/UNCOVERING A STRUCTURE USING A TARPAULIN

(76) Inventor: Alain Gurdebeke, Baboeuf (FR)

(21) Appl. No.: 13/086,584

(22) Filed: Apr. 14, 2011

(30) Foreign Application Priority Data
Apr. 14, 2010 (FR) 1052849

(51) Int. Cl. E06B 9/42

(52) U.S. Cl. 160/127; 160/405

(57) ABSTRACT

Device for covering/uncovering a structure using a tarpaulin, including an inflatable tarpaulin and an inflation system capable of deploying, by inflation, the inflatable tarpaulin from an initial position and deflating the inflatable tarpaulin, the inflatable tarpaulin including a return means which is capable of returning the inflatable tarpaulin into said initial position when the system deflates the inflatable tarpaulin.

### BACKGROUND OF THE INVENTION

1. Field of the Invention The invention relates to covering and uncovering a structure using a tarpaulin.

2. Description of the Relevant Art

Currently, it is possible to cover surfaces manually using tarpaulins made of impermeable or non-impermeable fabric or woven material. However, automatic systems do not exist for covering and uncovering large surfaces using a tarpaulin, such as for example sports grounds or parts of buildings.

Moreover, when it is desirable for structures which have an opening which is located high up relative to the ground, for example a skip mounted on a vehicle, to be covered and uncovered using a tarpaulin, users have to climb onto the structure in order to position the tarpaulin manually. In this case, the users are in a high position relative to the ground, which involves the risk of the users falling and increases the danger of their work.

Currently, systems exist which include articulated arms located on automotive vehicles which permit users to deploy automatically a tarpaulin made of fabric onto the skips while remaining on the ground, thus avoiding having to climb onto the vehicle or on top of the skip. However, said systems are costly and inappropriate as they do not permit objects which protrude beyond the top of the skip to be covered completely. More specifically, when said systems deploy the tarpaulin onto the skip, said tarpaulin may be torn when sharp objects protrude beyond the skip. Moreover, said systems require the user to climb on top of the skip to monitor the deployment thereof, in order to cover the contents of the skip in an appropriate manner and to prevent possible tearing thereof.

Systems for covering/uncovering swimming pools using a tarpaulin also exist, such as for example fabrics made of plastics material which are deployed manually but which are not automated. Automatic systems also exist to deploy tarpaulins made of wooden or aluminum battens but these systems are costly, complex, insufficiently robust and often break down.

### SUMMARY OF THE INVENTION

In one embodiment, a device and a method for covering and uncovering a structure using a tarpaulin is provided which makes it possible to meet the aforementioned requirements and, in particular, to propose a device and a method for automatically covering structures, which are inexpensive and which are simple to use.

According to one feature, a device is proposed for covering/uncovering a structure using a tarpaulin, including an inflatable tarpaulin and an inflation system capable of deploying, by inflation, the inflatable tarpaulin from an initial position and deflating the inflatable tarpaulin.

In this device, the inflatable tarpaulin includes a return means which is capable of returning the inflatable tarpaulin into said initial position when the system deflates the inflatable tarpaulin.

Using the return means, an automatic means is provided for covering and uncovering any type of structure using a tarpaulin.

Moreover, using an inflatable tarpaulin, it is possible to deploy, in an automatic and sufficiently slow manner, the tarpaulin onto the structure to be covered using a tarpaulin so as to protect the tarpaulin from possible tearing relative to the deployment of a single fabric tarpaulin.

The initial position may, for example, correspond to a rolled-up position of the inflatable tarpaulin.

This makes it possible to reduce the surface-area required to store the tarpaulin when said tarpaulin is not deployed.

The return means may include at least one spiral spring.

According to one embodiment, the inflation system includes a fluid reservoir, an inflation circuit coupled to the fluid reservoir and to the inflatable tarpaulin, and an inflation valve respectively controlled to fill and empty the inflatable tarpaulin using fluid.

Thus, a simple and compact means is provided for covering and uncovering any type of structure using a tarpaulin.

The fluid may be compressed air or incompressible liquid.

It is also possible to provide a means for covering and uncovering a structure using a tarpaulin which uses pneumatic or hydraulic forces and which consumes very little electrical energy.

Advantageously, the device includes holding means for holding the inflatable tarpaulin in a deployed position when said tarpaulin is inflated or deflated.

According to a further embodiment, the device includes a telescopic mast to receive the inflatable tarpaulin and a lifting circuit for the telescopic mast coupled to the fluid reservoir and provided with a lifting valve controlled for lifting and lowering the telescopic mast.

Using an adjustable mast, it is possible to adjust the height of the tarpaulin so as to position said tarpaulin above the structure to be covered using a tarpaulin. It is thus possible to prevent the inflatable tarpaulin from tearing when covering and uncovering the structure using a tarpaulin.

According to a further feature, a method for covering/uncovering a structure using a tarpaulin is proposed, in which an inflatable tarpaulin is inflated to deploy it from an initial position.

In this method, the inflatable tarpaulin is deflated to return the inflatable tarpaulin into said initial position.

According to one embodiment, the inflatable tarpaulin is held in a deployed position when said inflatable tarpaulin is inflated or deflated.

### BRIEF DESCRIPTION OF THE DRAWINGS

Further advantages and features will appear from examining the detailed description of embodiments and implementations of the invention which are not in any way limiting, and the accompanying drawings, in which:

FIG. 1 illustrates schematically a device for covering and uncovering a structure using a tarpaulin according to one embodiment;

FIG. 2 illustrates schematically an embodiment for covering a skip of an automotive vehicle using a tarpaulin;

FIG. 3 illustrates schematically an embodiment for holding a tarpaulin on the skip;

FIG. 4 illustrates schematically an embodiment for uncovering the skip using a tarpaulin; and

FIGS. 5 and 6 illustrate schematically further embodiments.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

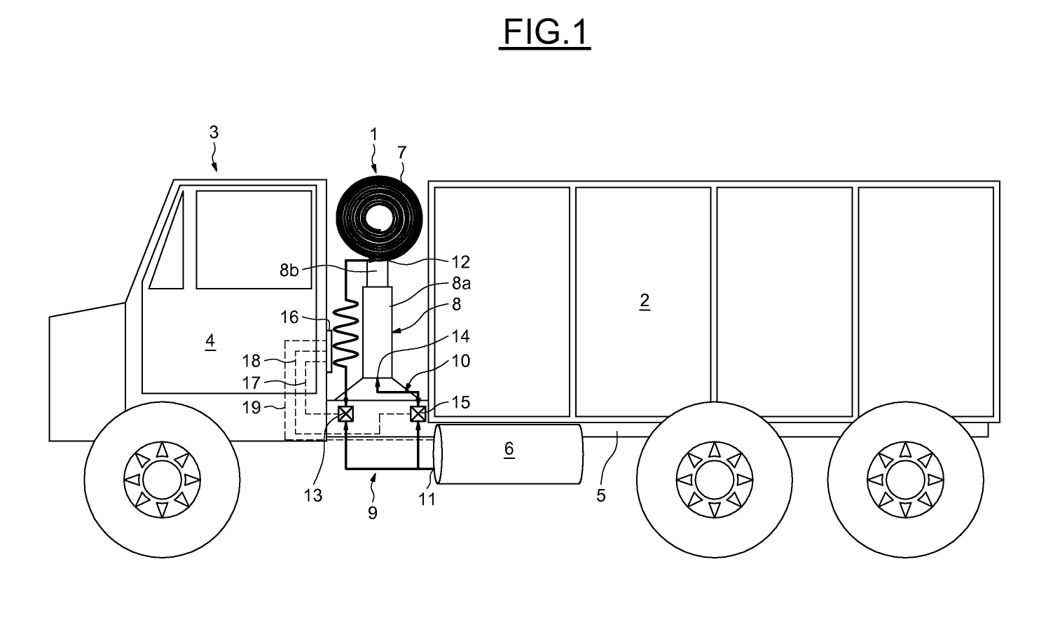

A device 1 for covering and uncovering a structure using a tarpaulin according to one embodiment has been shown in FIG. 1. In this embodiment, the device is particularly well suited to a skip 2 of an automotive vehicle 3. Naturally, said device may be used to cover/uncover other types of structure using a tarpaulin, such as for example a swimming pool, part of a building, a pit, etc.

In FIG. 1, the automotive vehicle 3 includes a driver's cab 4 of the vehicle, located at the front of the vehicle 3, and a platform 5 designed to receive the skip 2 and located to the rear of the driver's cab 4.

The device 1 for covering and uncovering a structure using a tarpaulin further includes an inflatable tarpaulin 7 and an inflation and deflation system 9 for the inflatable tarpaulin 7.

The inflation and deflation system 9, denoted hereinafter as the inflation system, includes a fluid reservoir 6 which may either be compressed air or an incompressible liquid when it is respectively desirable to use pneumatic or hydraulic forces.

The inflation system 9 is coupled to an outlet 11 of the reservoir 6 and to an inlet 12 of the inflatable tarpaulin 7. The inflation system 9 is further provided with an inflation valve 13 controlled to inflate and deflate the inflatable tarpaulin 7.

The device 1 also includes a telescopic mast 8 and a lifting and lowering circuit 10 for the telescopic mast 8.

The lifting and lowering circuit 10, denoted hereinafter as the lifting circuit, is connected to the outlet 11 of the reservoir 6 and to an inlet 14 of the telescopic mast 8. The lifting circuit 10 is further provided with a lifting valve 15 controlled to lift and lower the telescopic mast 8.

The device 1 also includes a control panel 16 for controlling the inflation valve 13, the lifting valve 15 and the reservoir 6, respectively via connections 17, 18 and 19. Said control panel 16 is located at a suitable height so that the user may control from the ground the inflation/deflation and the lifting/lowering of the mast, without having to climb onto the vehicle 3.

The control for opening/closing the fluid reservoir 6 is itself automatic depending on the commands received by the control panel 16.

The telescopic mast 8 includes at least two parts 8a, 8b. A first part 8a includes a cylindrical element mounted fixedly on a base to fix the telescopic mast 8 to the vehicle 3. The telescopic mast 8 is preferably fixed to the platform 5 between the driver's cab 4 and the skip 2, but naturally it may be fixed to other parts of the vehicle 3, for example to the rear of the skip 2. The second part 8b includes a further cylindrical element of which the diameter is less than that of the cylindrical element of the first part 8a. Moreover, the second part 8b is capable of being displaced upwards, and vice versa, under the action of fluid leaving the reservoir 6 which is controlled by the opening and closing of the lifting valve 15. Moreover, the second part 8b of the telescopic mast 8 has its upper end fixed to the inflatable tarpaulin 7 and permits the lifting and lowering thereof according to requirements.

The inflatable tarpaulin 7 is in an initial position corresponding to a rolled-up position when said tarpaulin is stored, i.e. when the inflatable tarpaulin 7 is not deployed.

The inflatable tarpaulin 7 is mounted on top of the telescopic mast 8. It includes at least one spring, preferably a spiral spring, which is wound back onto itself when the inflatable tarpaulin 7 is deflated. Moreover, said spiral spring, not shown in the figure for reasons of simplicity, is housed in a sheath provided inside the inflatable tarpaulin 7. As a variant, the inflatable tarpaulin 7 may include a plurality of sheaths, each for housing a spiral spring.

An embodiment of the method for covering/uncovering a structure using a tarpaulin, applied to the skip 2 of a vehicle 3 and disclosed above, will be illustrated in FIGS. 1 to 4.

The method for covering/uncovering, denoted hereinafter as the method for covering, a skip of a vehicle using a tarpaulin includes the following steps.

In FIG. 1, an initial step of the method for covering a structure using a tarpaulin is shown, in which the inflatable tarpaulin 7 is in an initial position where it is rolled up. In this initial position, the inflation valve 13 and the lifting valve 15 are closed and prevent the fluid from leaving the reservoir 6. This initial step may be carried out before loading the skip 2. The telescopic mast 8 is in this case in a lower position.

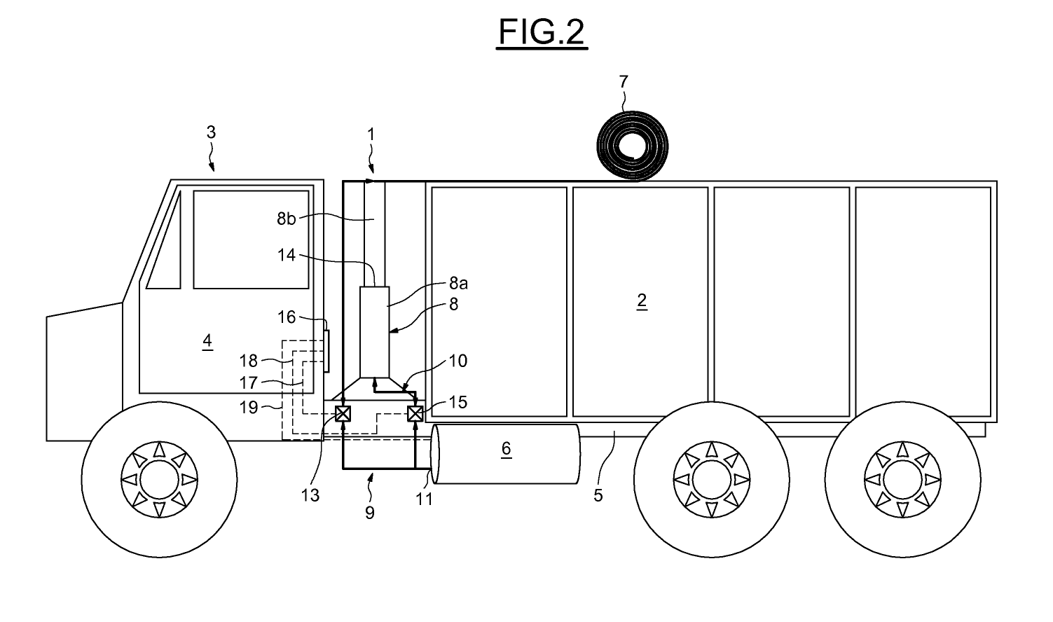

An embodiment of covering the skip 2 using a tarpaulin is shown in FIG. 2.

When it is desired to cover the skip 2 using a tarpaulin, the lifting valve 15 is opened so as to deploy the telescopic mast to adjust the height of the inflatable tarpaulin 7 relative to the height of the skip 2. Under the action of the circulation of fluid in the lifting circuit 10, from the reservoir 6, the second part of the mast 8b is deployed upwards and causes the inflatable tarpaulin 7 to be lifted. It is also possible to provide that the height of the skip 2 is exceeded so that the inflatable tarpaulin 7 may be positioned above bulky objects which could protrude beyond the opening of the skip 2. Then, the inflation valve 13 is opened so as to unroll the inflatable tarpaulin onto the skip 2. Under the action of the circulation of fluid in the inflation circuit 9, from the reservoir 6, the inflatable tarpaulin 7 is deployed over the entire length of the skip as far as the rear end thereof, or even beyond, in the case where a length of tarpaulin is provided which is greater than the length of the skip 2.

The spiral spring is thus configured so that the return force thereof is less than the force generated by the inflation of the inflatable tarpaulin 7 so that said tarpaulin may be deployed.

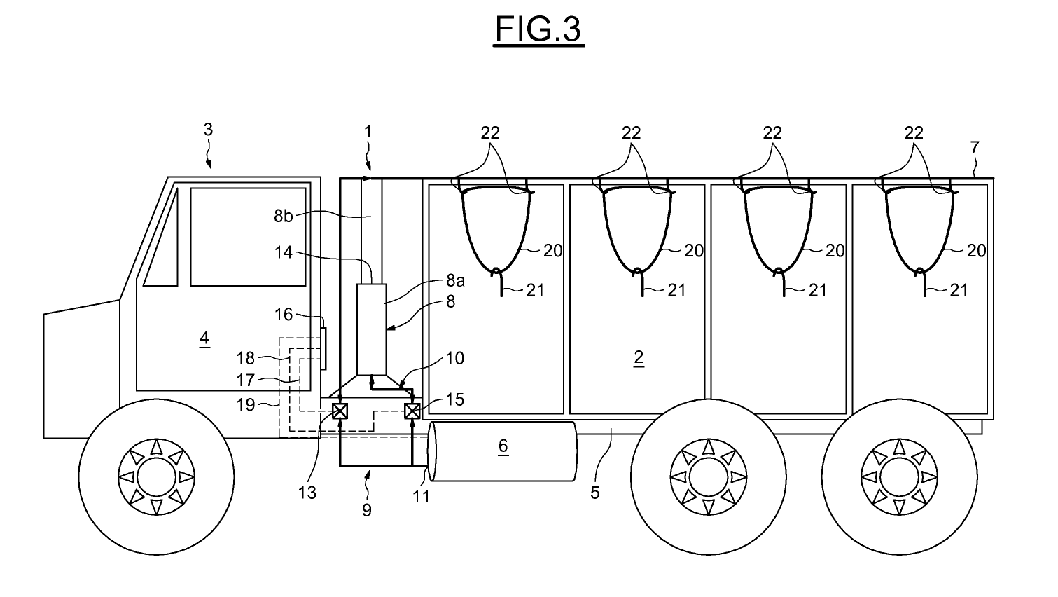

An embodiment for holding a tarpaulin on the skip 2 has been shown schematically in FIG. 3.

Once the inflatable tarpaulin 7 has been deployed on the skip 2, it is possible to hold the inflatable tarpaulin 7 using holding means.

Said holding means may, for example, be straps 20 mounted on hooks 21 provided on the upper part of the skip 2 and on hooks 22 provided on the lateral edges of the inflatable tarpaulin 7.

Then the telescopic mast 8 is locked in position using blocking means, such as for example by closing the lifting valve 15. Then the fluid may be released from the inflation circuit 9 by opening the inflation valve 13 towards the outside, or towards an additional reservoir, not shown in the figure, so as to empty the inflation circuit 9. The vehicle may then be moved in complete safety to transport the contents of the skip 2.

The holding means are thus configured so that the holding force is greater than the return force generated by the spiral spring so that the inflatable tarpaulin 7 may be held in a deployed position.

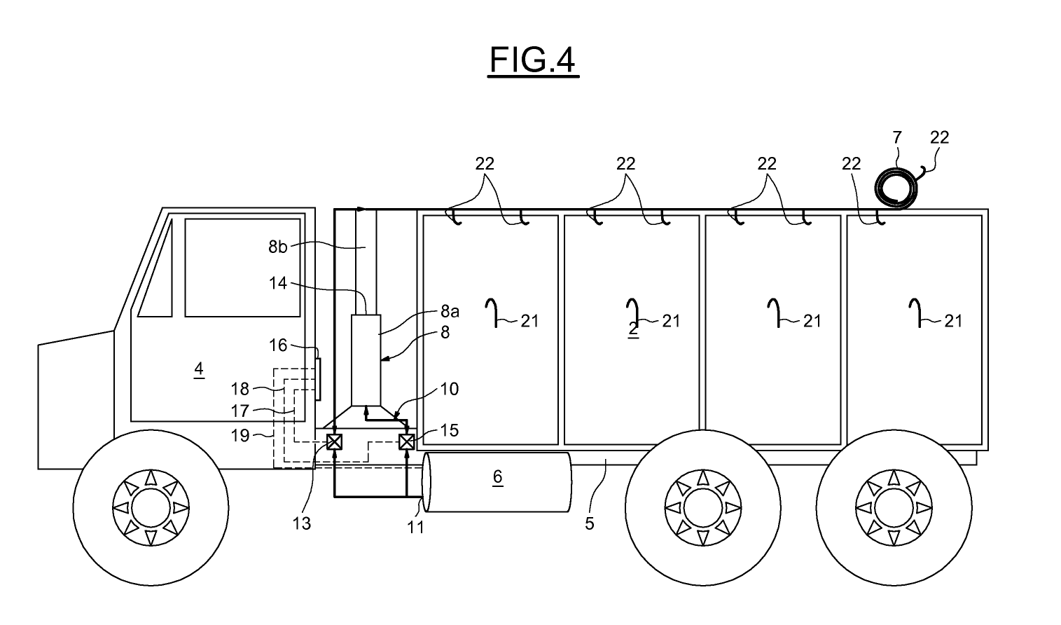

An embodiment for uncovering the skip 2 using a tarpaulin has been shown in FIG. 4.

When the vehicle is stationary, the inflatable tarpaulin is deflated by opening the inflation valve 13 towards the outside, or towards an additional reservoir not shown in the figure, so as to deflate the tarpaulin almost entirely. After this deflation step of the inflatable tarpaulin 7, the straps 20 are removed from all the hooks 21, 22. By deflating the inflatable tarpaulin 7, the rigidity thereof reduces and, as a result, the spiral springs are unwound due to the return force thereof, causing the inflatable tarpaulin 7 to be automatically rolled up onto itself. During the deflation of the inflatable tarpaulin 7, the return force of the spiral spring becomes greater than the force generated by the pressure prevailing in the inflatable tarpaulin 7, and said inflatable tarpaulin adopts its initial position again.

Thus, using the method and the device which have been described above, an automatic method is provided for covering and uncovering a structure using a tarpaulin, such as for example a skip of a vehicle, in a simple manner.

Said method and said device are particularly suitable for open skips, of which the height of the contents may exceed the top of the skip and which prevent potential tearing caused by sharp objects.

In a further embodiment, it is possible to use the hydraulic or pneumatic systems which are already in place on vehicles for controlling brakes, or other systems which use pneumatic or hydraulic forces. In this manner, the vehicle is not overloaded and the electrical consumption thereof is reduced.

The location of the mast placed between the driver's cab of the vehicle and the skip makes it possible to be able to remove or mount easily the skip on the rear platform of the vehicle when said vehicle is configured for transporting removable skips.

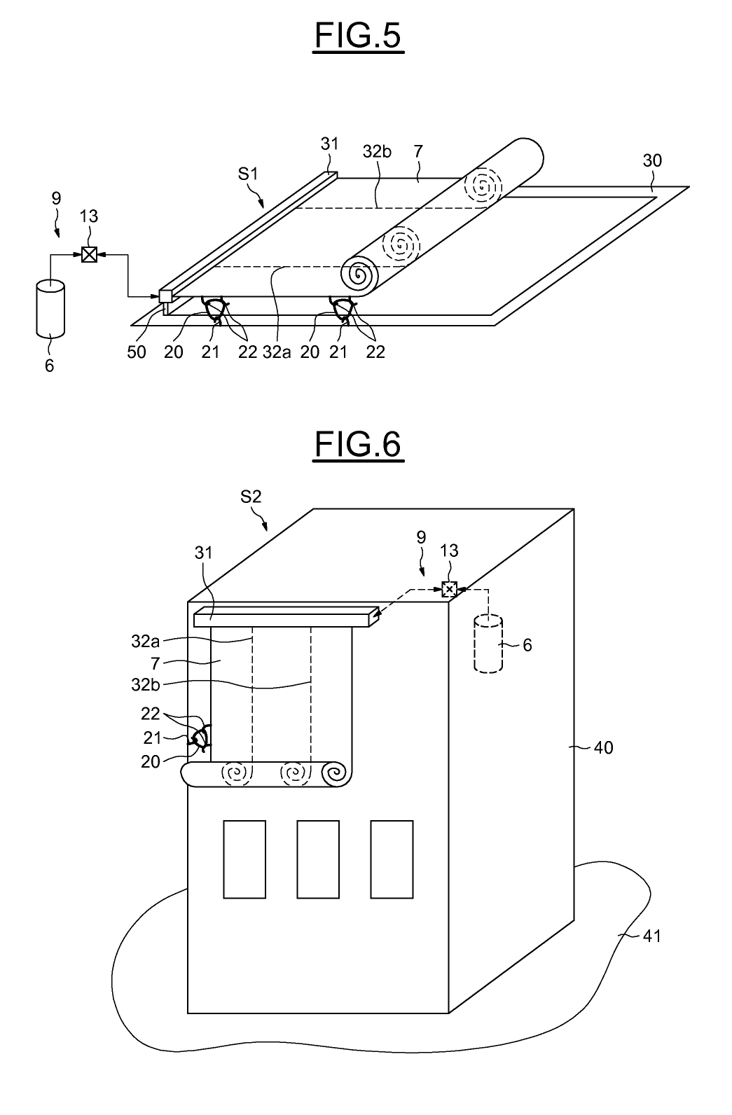

A further embodiment in which a device 51 for covering/uncovering a structure using a tarpaulin is used for covering/uncovering a swimming pool 30 using a tarpaulin has been shown schematically in FIG. 5.

The device 51 includes certain elements disclosed in the preceding figures. In particular, it includes a non-telescopic mast 50, mounted on one of the edges of the swimming pool 30, and on which the inflatable tarpaulin 7 is mounted via a fluid distribution circuit 31.

The fluid distribution circuit 31 is coupled to the inflation system 9, disclosed above in FIG. 1, and permits, in particular, the fluid to be uniformly distributed in the inflatable tarpaulin 7.

As a variant, the non-telescopic mast 50 may be replaced by the telescopic mast 8 disclosed in FIG. 1.

Two spiral springs 32a, 32b have also been shown which form the return means of the inflatable tarpaulin 7.

In FIG. 6, a further embodiment has been shown schematically in which a device S2 for covering/uncovering a structure using a tarpaulin is used for covering/uncovering part of a building 40 using a tarpaulin.

The device S2 includes certain elements disclosed in the preceding figures. In particular, said device S2 permits the inflatable tarpaulin 7 to be deployed substantially perpendicular to the ground 41.

As a variant, the inflation system 9 shown here in dashed lines, may be incorporated inside or outside the building 40.

The device and the method for covering/uncovering a structure using a tarpaulin which have been disclosed above are thus suitable for automating the covering/uncovering of any type of structure using a tarpaulin.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. Device for covering/uncovering a structure using a tarpaulin, comprising an inflatable tarpaulin and an inflation system capable of deploying, by inflation, the inflatable tarpaulin from an initial position and deflating the inflatable tarpaulin, wherein the inflatable tarpaulin comprises a return means which is capable of returning the inflatable tarpaulin into said initial position when the system deflates the inflatable tarpaulin.

2. Device according to claim 1, in which the initial position corresponds to a rolled-up position of the inflatable tarpaulin.

3. Device according to claim 1, in which the return means comprises at least one spiral spring.

4. Device according to claim 1, in which the inflation system comprises a fluid reservoir, an inflation circuit coupled to the fluid reservoir and to the inflatable tarpaulin, and an inflation valve respectively controlled to fill and empty the inflatable tarpaulin using fluid.

5. Device according to claim 1, in which the fluid is compressed air or incompressible liquid.

6. Device according to claim 1, comprising holding means for holding the inflatable tarpaulin in a deployed position when said inflatable tarpaulin is inflated or deflated.

7. Device according to claim 1, comprising a telescopic mast to receive the inflatable tarpaulin and a lifting circuit for the telescopic mast coupled to the fluid reservoir and provided with a lifting valve controlled for lifting and lowering the telescopic mast.

8. Method for covering/uncovering a structure using a tarpaulin, in which an inflatable tarpaulin is inflated to deploy it from an initial position, wherein the inflatable tarpaulin is deflated to return the inflatable tarpaulin into said initial position.

9. Method according to claim 8, in which the inflatable tarpaulin is held in a deployed position when said inflatable tarpaulin is inflated or deflated.
